(19) United States
(12) Patent Application Publication
(10) Pub. No.: US 2023/0272219 A1
(43) Pub. Date: Aug. 31, 2023

(54) SPREADING CATIONIC EMULSION

(71) Applicant: VINCI CONSTRUCTION, Nanterre (FR)

(72) Inventors: Thomas LEBARBE, AUDENGE (FR); Frédéric DELFOSSE, PESSAC (FR); Marie-Laure PIERRE, VILLENAVE D'ORNON (FR)

(73) Assignee: VINCI CONSTRUCTION, Nanterre (FR)

(21) Appl. No.: 18/014,077

(22) PCT Filed: Jul. 1, 2021
(86) PCT No.: PCT/FR2021/051207

§ 371 Date: Dec. 30, 2022

(30) Foreign Application Priority Data
Jul. 1, 2020 (FR) 2006961

(51) Int. Cl. C08L 95/00; C09D 5/02; C09D 5/44

(52) U.S. Cl. CPC C08L 95/005; C09D 5/027; C09D 5/4492; C08L 2201/54; C08L 2555/40

(57) ABSTRACT

The present disclosure relates to the field of so-called “spreading” emulsions of hydrocarbon binder, in particular cationic emulsions of hydrocarbon binders. Such emulsions are useful in the preparation of surface dressings, tack coats, fog seal type surface courses and paver seams. The use of an anionic polymer to improve immediate adhesiveness of a cationic emulsion of hydrocarbon binder to solid particles is particularly described.

### FIELD OF THE INVENTION

The present invention relates to the field of so-called “spreading” emulsions of hydrocarbon binders, in particular cationic emulsions of hydrocarbon binders. Such emulsions are useful in the preparation of surface dressings, tack coats, fog seal type surface courses and paver seams. More particularly, the present invention is directed to the use of an anionic polymer to improve immediate adhesiveness of a cationic emulsion of hydrocarbon binder to solid particles.

### BACKGROUND OF THE INVENTION

Emulsions of hydrocarbon binder, in particular bitumen emulsions, are commonly used for various road applications, where they can be spread alone to obtain, for example, tack coats, impregnation coats, and surface courses (fog seal type), either in the presence of granulates to make surface dressings. Emulsions of hydrocarbon binders can also be mixed with granulates to obtain cold mix, either just before application (Cold Cast Bituminous Materials and Remixing), or in mixing plants (storable plant mix, Emulsion Gravel, Emulsion Bituminous Concretes). The present invention relates to road applications where emulsions are spread.

Bitumen emulsions are obtained by dispersing bitumen droplets in an aqueous phase. Bitumen droplets are stabilized in the continuous phase by surfactant compounds that can be anionic, non-ionic, amphoteric, or cationic. Bitumen emulsions used in the road industry are mainly cationic in nature. These emulsions are defined and characterized according to different standards and specifications. European standard EN 13808: 2013 defines technical specifications for cationic bitumen emulsions used in road construction, road infrastructure maintenance, airports and other road surfaces. This European standard applies to bitumen emulsions, fluxed bitumen emulsions, polymer modified bitumen emulsions and polymer modified fluxed bitumen emulsions, which also include latex modified bitumen emulsions.

Cationic surfactants are more versatile compared to anionic surfactants because cationic surfactants enable manufacture of bitumen emulsions that can be employed with a wide range of granulates (mineral solid particles), specifically granulates that contain different silica concentrations. Materials comprising silica mainly carry negative charges on their surface and cationic bitumen emulsions are therefore promoted due to the positive charge of bitumen droplets which allows attraction of droplets at the surface of granulates. This attraction enables fast breaking kinetics (demulsification) and thus a rapid reopening of the road surface to traffic.

Breakage of bitumen emulsions is related to a multitude of physicochemical phenomena that occur upon contacting the emulsion with the granulates. First, positively charged cationic surfactants and bitumen droplets are attracted to the electronegative surface of mineral solids particles by electrostatic attraction and electrophoresis. Hydrolysis phenomena of the surface of mineral solid particles can also lead to a pH rise that neutralizes cationic surfactants. As these phenomena lead to a depletion of the density of cationic charges at the bitumen/water interfaces, bitumen droplets are destabilized and phenomena of flocculation, coalescence and film formation of the binder lead to complete breakage of the emulsion and setting of the material/road surface.

However, despite the destabilization of bitumen emulsions in contact with solid mineral particles, complete breakage of the emulsion is partially determined by water evaporation. The use of bitumen emulsions is sometimes limited to certain specific fields of use or some weather conditions because they have certain drawbacks, namely a) they are early sensitive to rain and b) it takes a relatively long time before the binder develops its maximum consistency.

In the case of bitumen emulsions for spreading applications and in particular for a surface dressing or a tack coat, some techniques are known to the skilled person to accelerate breaking kinetics of the emulsion. An example of this is the simultaneous spreading of a bitumen emulsion and a breaking agent on the roadway which is projected into the emulsion jets and which allows the emulsion to break quickly and homogeneously when it is spread.

EP 0491107 describes a two-component composition comprising an anionic or cationic-type bitumen emulsion and a breaking additive comprising a neutralizing substance.

FR 2760461 describes a bitumen emulsion comprising an encapsulated breaking agent allowing control of emulsion breakage, wherein capsule breakage results from a mechanical effect. The breaking agent may be an aqueous solution of a strong mineral base (NaOH) or an anionic surfactant (such as an alkylsulfate, alkylsulfonate or alkylsulfosuccinate or a mixture thereof) or an anionic polymeric agent.

EP 1275625 describes the use of a hydraulic binder suspended in a bitumen emulsion in order to accelerate emulsion breakage. The invention specifically relates to a cement treated with magnesium stearate in order to make it hydrophobic and thus ensure stability of the bitumen emulsion modified by the hydraulic binder. The hydraulic binder becomes active in the formula upon contacting the bitumen emulsion with the mineral particles. EP 0246063 describes a method for reducing the setting time of a cationic bitumen emulsion, which method consists of incorporating into said emulsion an effective amount of a solution of a cationic emulsifier and a sufficient amount of a polymer chosen from the group of polymers of acrylic acid, methacrylic acid, mixtures thereof, or salts thereof to form an operable emulsion that hardens in less than about 40 minutes. The low molecular weight polymer (less than 100,000 g/mol) is generally added to said cationic bitumen emulsion as a mixture comprising 0.1 to 2.0 parts by weight on a dry basis of said low molecular weight polymer and 100 parts by weight on a dry basis of a polymer latex. The mixture is made in the form of anionic latices which are then made cationic by adding a proportion of up to 10% of the total polymer weight, a cationic emulsifier and adjusting the pH to a value below about 5.

Acceleration of emulsion breaking kinetics is one of the quality criteria of bitumen emulsion spreading applications. However, the breaking kinetics do not meet all the expectations and requirements of these applications. Acceleration of emulsion breaking kinetics does not dictate the early age behavior of bituminous products. Thus, simply accelerating the breaking kinetics of emulsions does not provide a solution to the potential problems of early age leaching bituminous products or early age gritting problems for a surface dressing. Indeed, only strong and rapid adhesiveness of the hydrocarbon binder to mineral particles decreases the early age sensitivity of bituminous products to rain. In addition, an emulsion with a low breaking index will imply a rapid breakage of the emulsion but poor adhesiveness to the granulates due to insufficient wetting of the emulsion to the granulates.

Thus, there is still need for providing a solution that is simple to implement, allowing the early age behavior of bituminous products applied by spreading to be altered, in particular for limiting early age leaching/washout of bituminous products by rainwater without negatively impacting properties of the emulsions (storage stability, breaking index, adhesiveness, etc.).

### BRIEF DESCRIPTION OF THE INVENTION

The present invention relates to the use of an anionic polymer to improve immediate adhesiveness of a spreading cationic emulsion of hydrocarbon binder to solid particles upon preparing a bituminous product, said anionic polymer comprising only acidic ionizable groups whose pKa ranges from 4 to 5, having an anionicity rate ranging from 50 to 100% and a molecular weight ranging from 500 to 500,000 g/mol.

The present invention also relates to a method for improving immediate adhesiveness of a spreading cationic emulsion of hydrocarbon binder to solid particles upon preparing a bituminous product, said method comprising preparing a cationic emulsion of a hydrocarbon binder comprising an anionic polymer as presently described.

### DETAILED DESCRIPTION OF THE INVENTION

Unexpectedly, it has been discovered that cationic emulsions of a hydrocarbon binder comprising an anionic polymer as defined below have an improved immediate adhesiveness without any change in the properties of the emulsion in relation to the storage and the requirements of the use for which they are intended (viscosity, passive adhesiveness, cohesion). Advantageously, properties of the emulsions remain compliant with NF EN 13808 (2013) standard and properties required for the preparation of bituminous products by spreading a cationic emulsion of a hydrocarbon binder.

The term “spreading” as used in the present description means the action of applying an of hydrocarbon binder to a surface. The emulsion can be applied to a surface comprising solid particles as described below and/or be covered after applying solid particles as described below. Said surface may be a layer of solid particles or a support. In this way, spreading techniques differ from coating techniques in which emulsion and solid particles are mixed and applied. It is therefore understood that the emulsions currently described are spreading emulsions as opposed to coating emulsions.

Thus, the cationic emulsions of hydrocarbon binder comprising an anionic polymer as defined below have good stability (storage, transport), offer good wettability of solid particles, strong active (immediate adhesiveness) and passive adhesiveness to solid particles, good cohesion and advantageously enable a final consistency to be obtained more quickly (cohesion rise) than those of commonly prepared bituminous products.

Such emulsions allow the preparation of superficial wear coats, tack coats, surface courses, in particular fog seal coats, and paver seams that provide greater early age robustness. For example, upon preparing surface dressings, a good immediate quantitative adhesiveness to solid particles (granulates) is obtained. The resulting cohesion allows circulation on the coating only 15-30 minutes after applying the emulsion. Therefore, this minimizes risks of leaching.

Anionic Polymers and their Use

The present invention relates to the use of an anionic polymer as defined below to improve immediate adhesiveness of a cationic emulsion of hydrocarbon binder to solid particles upon preparing a bituminous product by spreading the emulsion.

The immediate adhesiveness improvement is measured by comparing immediate adhesiveness of a cationic emulsion of a hydrocarbon binder comprising an anionic polymer as defined below to solid particles to that of a cationic emulsion of a hydrocarbon binder not comprising an anionic polymer as defined below to solid particles. Immediate adhesiveness is measured by a modified protocol of the test of TS16346 2013 standard as modified in 2019. The modified protocol of the test of TS16346 2013 standard is described in AFNOR document N123-A2f (2019). Advantageously, according to this modified protocol, immediate quantitative adhesiveness greater than 90% after less than eight water washes, or even less than four water washes, or even one or two water washes, after a compact mass rest time of 10 minutes, is obtained.

Advantageously, the anionic polymers described below improve immediate adhesiveness of cationic emulsions of hydrocarbon binder while not adversely affecting properties of hydrocarbon binder emulsions. The emulsions remain stable when being prepared, stored and transported. Good performance in the passive adhesiveness test according to the NF EN 13614 standard (June 2011) is also obtained. Advantageously, the anionic polymers described below accelerate breakage of the cationic emulsions of hydrocarbon binder. The present invention also relates to a method for improving the immediate adhesiveness of a cationic emulsion of hydrocarbon binder to solid particles upon preparing surface dressings, tack coats, surface courses, in particular of the fog seal type, and paver seams by spreading the cationic emulsion which comprises adding an anionic polymer as described below to a cationic emulsion of hydrocarbon binder. In other words, the process comprises preparing a cationic emulsion of hydrocarbon binder comprising adding an anionic polymer as described below to a cationic emulsion of hydrocarbon binder. The cationic emulsion of hydrocarbon binder may be as described below.

The present invention also relates to a method for reducing leaching of bituminous products such as early age surface dressings, tack coats, fog seal-type surface courses and paver seams which comprises preparing a bituminous product by spreading, typically by spraying, a cationic emulsion of hydrocarbon binder as described below. Bituminous products prepared with such an emulsion may be as described below.

Anionic Polymers

The anionic polymers useful in the scope of the present invention are polymers bearing acidic ionizable groups. They can be referred to as polyelectrolytes. Acid ionizable groups may be in free form or be neutralized, for example by sodium, potassium, lithium or ammonium hydroxides, to yield the corresponding salts. Thus, useful anionic polymers in the present invention may be in free form or as salts, such as sodium or ammonium salts. Useful anionic polymers in the present invention only carry acidic ionizable groups whose pKa ranges from 4 to 5.

The term “pKa” as used in this description refers to the logarithm of the acidity constant of an acid, that is the equilibrium constant of the dissociation reaction of an acid. pKa is specific to each acidic species and depends on the solvent and temperature considered for the dissociation reaction. In the context of the present invention, pKa values are expressed for a dissociation reaction carried out in water at a temperature of 25° C. Anionic polymers carrying acidic ionizable groups with pKa less than 4 have been shown to lead to premature emulsion breakage during storage. Anionic polymers carrying acidic ionizable groups with a pKa greater than 5 in turn lead to too long breakage times. Examples of acidic ionizable groups with pKa ranging from 4 to 5 include carboxylic (COOH) and phosphonic groups. Anionic polymers may therefore comprise acidic ionizable groups chosen from carboxylic, phosphonic groups and mixture thereof. Thus, useful anionic polymers in the scope of the present invention may result from the polymerization of acidic ionizable monomers comprising one or more carboxylic and/or phosphonic groups. Ionizable monomers comprising one or more carboxylic groups may thus be chosen from the group comprising acrylic acid, methacrylic acid, maleic acid, itaconic acid, fumaric acid and mixtures thereof.

Useful anionic polymers in the present invention may be homopolymers, copolymers, or mixtures thereof. Copolymers may result from the copolymerization of different acidic ionizable monomers, such as monomers described above or from the copolymerization of acidic ionizable monomers with other co-monomers, for example chosen from acrylamide, acrylic acid esters, and methacrylic acid esters.

In some embodiments, useful anionic polymers in the present invention correspond to the following formula (I):

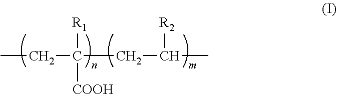

wherein
R₁ is a hydrogen, a C₁-C₆ alkyl group or a —CH₂COOH group,
R₂ is chosen from NH₂—CO— or R₃—O—CO—, groups,
R₃ is a C₁-C₆ alkyl group or a phosphonic group,
n and m are such that the ratio n/(n+m) is equal to or greater than 0.5, or even greater than or equal to 0.7.

The compound of the formula (I) usually corresponds to a poly(carboxylate) obtained by polymerization of acrylic acid or methacrylic acid.

In addition, useful anionic polymers in the present invention are highly anionic. The proportion in number of ionizable monomers in relation to the total number of monomers (referred to here as anionicity rate) ranges from 50% to 100%, or even from 70% to 100%.

It is preferably 100%. The high anionicity of anionic polymers makes it possible to neutralize positively charged bitumen particles that are thereby destabilized.

The molecular weight of useful anionic polymers in the scope of the present invention ranges from 500 to 500,000 g/mol, preferably from 1000 to 250,000, even more preferably from 2000 to 150,000 g/mol. Such molecular weights ensure good diffusion of ionic charges around bitumen particles.

Examples of useful anionic polymers in the scope of the present invention include acrylic acid homopolymers, acrylic acid/acrylamide copolymers, maleic acid/acrylic acid copolymers, methacrylic acid homopolymers, acrylic acid/methacrylic acid copolymers, acrylic acid and acrylate copolymers, acrylic acid terpolymers.

Examples of useful anionic polymers in the scope of the present invention particularly include products marketed by SNF-Floerger under the names FLOSPERSE 3030 NCA W 30 and FLOSPERSE CT 39 A.

Cationic Emulsion of Hydrocarbon Binder

The cationic spreading emulsion comprises:
a hydrocarbon binder;
an aqueous phase (typically water);
a cationic surfactant;
an acid; and
an anionic polymer as defined previously or a salt thereof.

The pH of the aqueous phase is typically set to a value between 1.5 and 2.5 using an acid (hydrochloric acid, orthophosphoric acid, etc.) so that ionizable functions of the anionic polymer as defined previously are in non-ionic form (carboxylic acid or phosphonic acid). Advantageously, the cationic emulsion has an immediate adhesiveness to solid particles according to a modified protocol of the test of TS16346 (N123-A2f, 2019) standard greater than 90% after less than eight water washes, or even less than four water washes, or even one or two water washes, after a compact mass rest time of 10 minutes.

The cationic emulsion typically comprises from 0,005 to 0.5%, or even from 0.01% to 0.1% by mass of an anionic polymer or mixtures thereof relative to the total mass of the cationic emulsion.

The different constituents of the cationic emulsion are as described below.

Hydrocarbon Binder

The term “hydrocarbon binder” as used in this description means any hydrocarbon binder of fossil, vegetable or synthetic origin usable for the production of so-called “bituminous” products.

The hydrocarbon binder may be pure or modified, particularly by the addition of polymers.

The hydrocarbon binder may be a soft to hard binder, advantageously having a grade ranging from 10/20 to 160/220.

In some embodiments, the hydrocarbon binder is a pure bitumen or a bitumen modified by polymers as described below.

The bitumen-modifying “polymers” referred to herein may be chosen from natural or synthetic polymers. These are, for example, polymers of the family of synthetic or natural elastomers, and in indicating and non-limiting way:
random, multi-sequenced or star copolymers of styrene and butadiene or of isoprene in all proportions (in particular styrene-butadiene-styrene block copolymers (SBS), styrene-butadiene (SB, SBR for styrene-butadiene rubber), styrene-isoprene-styrene block copolymers (SIS) or copolymers of the same chemical family (isoprene, natural rubber, etc.), possibly crosslinked in-situ,
vinyl acetate and ethylene copolymers in all proportions,
   ethylene and esters of acrylic acid, methacrylic acid or maleic anhydride copolymers, ethylene and glycidyl methacrylate copolymers and terpolymers, and
polyolefins.

Bitumen-modifying polymers may also be chosen from reclaimed polymers, for example “reground rubber” or other rubber-based compositions reduced to pieces or powder, for example obtained from used tires or other polymer-based waste (cables, packaging, agriculture, etc.) or any other polymer commonly used for the modification of bitumen such as those cited in the Technical Guide written by the International Road Association (AIPCR) and edited by the Laboratoire Central des Ponts et Chaussees “Use of Modified Bituminous Binders, Special Bitumens and Bitumens with Additives in Road Pavements” (Paris, LCPC, 1999), as well as any mixture in any proportion thereof.

It is understood that bitumen-modifying polymers as described above are polymers different from polymers useful for improving immediate adhesiveness of cationic emulsions of hydrocarbon binder.

Cationic and Acidic Surfactant

Upon manufacturing an emulsion, the hydrocarbon binder is dispersed as fine droplets in the continuous phase, for example in water, by a mechanical action. The addition of a surfactant forms a protective film around the droplets, preventing them from agglomerating and thereby allowing the mixture to be kept stable and stored for a period of time. The surfactant may be of petroleum, vegetable, animal origin or mixtures thereof (for example, the surfactant may be of vegetable and petroleum origin).

The surfactant may be an acidic soap, which is usually obtained by the action of an acid, typically hydrochloric acid, on one or two amines.

Relevant surfactants for road use include surfactants marketed by Akzo NOBEL (Redicote® E9, Redicote® EM 44, Redicote® EM 76), surfactants marketed by CECA (Dinoram® S, Emulsamine® L60, Polyram® S, Polyram® L 80), surfactants marketed by Meadwestvaco (Indulin®® R33, Indulin® R66, Indulin® W5). These surfactants can be used alone or in mixtures.

The emulsion comprises an acid which may be, for example, hydrochloric acid, as mentioned above or orthophosphoric acid.

Other Additives

The emulsion may further comprise additives commonly used in the road field, e.g. adhesiveness dopes, vegetable or petrochemical waxes, fatty acids, viscosifiers, thickeners, fluxing agents. The emulsion may contain synthetic or natural latex. The term “latex” as employed in this description refers to a dispersion of polymers (polyisoprene, SBS, SB, SBR, acrylic polymers, etc.) crosslinked or not crosslinked in an aqueous phase. This latex is incorporated in the aqueous phase before emulsification or in-line during emulsion manufacturing or even after emulsion manufacturing.

Preparation of the Cationic Emulsion

The spreading cationic emulsion is prepared according to methods well known to those skilled in the art. Typically, in some embodiments, the anionic polymer is added to the aqueous phase before emulsification.

Thus, the cationic emulsion can be prepared by a process comprising the following steps of:
a) incorporating an anionic polymer as defined above or a salt thereof into an aqueous phase comprising at least one cationic surfactant, the pH of the aqueous phase being between 1.5 and 2.5; and then
b) emulsifying the aqueous phase from step a) by adding a hydrocarbon binder.

The aqueous phase is acidified by adding an acid, preferably hydrochloric acid or orthophosphoric acid.

The anionic polymer is typically fully added in the aqueous phase in step a) before emulsification in step b).

In some embodiments, the anionic polymer is added after emulsification.

Thus, the cationic emulsion can be prepared by a process comprising the following steps of:
a) Preparing an emulsion by adding a hydrocarbon binder to an aqueous phase comprising at least one cationic surfactant, the pH of the aqueous phase being between 1.5 and 2.5;
b) incorporating an anionic polymer as defined above or a salt thereof into the emulsion from step a).

Bituminous Products

Cationic emulsions comprising an anionic polymer as described above can be used to prepare a variety of bituminous products by spreading techniques. spreading cationic emulsions comprising an anionic polymer as described above can thus be used to prepare surface dressings, tack coats, surface courses, in particular of the fog seal type, and paver seams. On the other hand, said cationic emulsions are not intended for preparing bituminous products obtained by coating solid particles with a hydrocarbon binder, such as cold- or hot-mixes, storable plant mixes or emulsion bituminous concretes.

Thus, the present invention is also directed to bituminous products, as described below, prepared using a cationic emulsion as described above.

Bituminous products comprising solid particles and a hydrocarbon binder may be prepared by a process comprising a step of bringing the solid particles into contact with a cationic emulsion as described above. The contact step is preferably carried out by spraying the cationic emulsion onto the solid particles or by spraying the cationic emulsion onto a support possibly followed by the application of solid particles (e.g. gritting). Typically, the step of contacting the solid particles with the cationic emulsion of the hydrocarbon binder is carried out in the absence of a breaking agent. However, in some embodiments, breaking agents, in particular a basic solution, may be used by simultaneous spreading in the emulsion jet in order to accelerate the effect of anionic polymers, especially when the solid particles are of an acidic nature, in particular when they comprise a significant amount of silica. This allows for a faster and more homogeneous breakage.

Thus, the present invention further relates to a method for spreading a spreading cationic emulsion of hydrocarbon binder for the preparation of a bituminous product, comprising spraying the cationic emulsion, said spreading cationic emulsion of hydrocarbon binder comprising an anionic polymer as described above.

Bituminous products prepared by the spreading method the invention are typically chosen from surface dressings, tack coats, surface courses, in particular of the fog seal type, and paver seams.

Thus, the present invention also relates to a method for preparing a bituminous product comprising a step of applying by spreading, typically by spraying, a spreading cationic emulsion of hydrocarbon binder on the surface of a layer comprising solid particles, said spreading cationic emulsion of hydrocarbon binder comprising an anionic polymer as described above.

The present invention also relates to a method for preparing a bituminous product comprising a step of applying by spreading, typically by spraying, a spreading cationic emulsion of hydrocarbon binder on the surface of a support followed by applying a layer of solid particles, said spreading cationic emulsion of hydrocarbon binder comprising an anionic polymer as described above.

Applying by spreading the cationic emulsion corresponds to contacting the cationic emulsion of a hydrocarbon binder with the surface of a layer of solid particles. For example, the emulsion can be applied to a surface with solid particles and/or be covered after application of solid particles.

Typically, the application by spreading is performed by spraying the hydrocarbon binder cationic emulsion on the surface of solid particles or spraying the cationic emulsion onto a support possibly followed by applying solid particles (e.g. gritting).

The method for preparing a bituminous product according to the invention makes it possible in particular to prepare products chosen from surface dressings, tack coats, surface courses, in particular of the fog seal type, and paver seams.

Solid Particles The term “solid particles” as used in this description means any solid particles usable for the manufacture of bituminous products, in particular for road construction. Examples of solid particles include solid mineral particles such as natural mineral granulates (stones, sand, fines) for example from quarries or gravel, recycling products such as plant mix aggregates, for example resulting from the recycling of materials reclaimed during road repair or surplus from mixing plants, manufacturing scrap, shingles (“tiles”, from the recycling of roofing membranes), granulates from the recycling of road materials including concrete, cinder in particular slag, shale in particular bauxite or corundum, reground rubber from tire recycling in particular, artificial granulates of any origin and granulates for example from refuse incineration clinker (RIC), as well as mixtures thereof in any proportion.

Solid particles, in particular mineral solids, for example natural mineral granules, for example natural mineral granulates typically comprise:
elements less than 0,063 mm (filler or fines);
sand with elements between 0,063 mm and 2 mm;
grits or granulates, the elements of which have dimensions
   between 2 mm and 6 mm;
   greater than 6 mm;

The size of solid particles, in particular mineral solid particles, for example mineral granulates, is measured by tests described in NF EN 933-2 standard (May 1996 version). By “plant mix aggregates”, it is meant fragments of plant mixes (mixture of granulates and bituminous binders) from milling plant mix coats, crushing of plates extracted from asphalt pavements, pieces of plant mix plates, plant mix waste or surplus mix plant production (surpluses of productions are materials that are coated or partially coated in a plant resulting from transitional phases of manufacture). These and other recycling products can reach dimensions up to 31.5 mm.

“Mineral solids” are also referred to as “mineral fraction 0/D”. This mineral fraction 0/D can be separated into two particle sizes: mineral fraction 0/d and mineral fraction d/D.

The finest elements (mineral fraction 0/d) shall be those in the range between 0 and a maximum diameter which can be set between 2 and 6 mm (from 0/2 to 0/6), advantageously between 2 and 4 mm. Other elements (minimum diameter greater than 2, 3, 4, 5 or 6 mm; and approximately up to 31.5 mm) constitute the mineral fraction d/D. Bituminous products are prepared according to methods known in the technical field.

Surface Dressings

Surface dressings are surface coatings as described in the «Enduits Superficiels d'Usure», Institut des Routes, des Rues et des Infrastructures pour la Mobilité, Cerema, September 2017. Typically, a surface dressing refers to a layer consisting of superimposed layers of a hydrocarbon binder and solid particles, in particular mineral solid particles. It is typically obtained by spraying a hydrocarbon binder and then spreading on this binder solid mineral particles, in one or more layers. The whole is then compacted. A surface dressing requires not only a binder that is fluid enough to be sprayed, but also a binder that allows good tack of the solid mineral particles to the support.

In the scope of the present invention, the surface dressings are prepared by spraying a cationic emulsion onto solid particles, in particular mineral solid particles, or by spraying a cationic emulsion onto a support and then spreading onto the cationic emulsion solid particles, in particular mineral solid particles.

The total hydrocarbon binder content in a surface dressing is adapted according to the structure of the dressing (mono- or two-layer, type of gritting), the nature of the hydrocarbon binder and the dimension of the mineral solid particles, in particular the granulates, by following for example the recommendations of the document “Enduits superficiels d'usure—Guide technique, May 1995”.

The hydrocarbon binder employed for the manufacture of a surface dressing may be bitumen being pure or modified by polymers, as previously described.

In the scope of the present invention, surface dressings are prepared by means of a cationic emulsion of a hydrocarbon binder typically comprising, relative to the total weight of the cationic emulsion, from 0.01% to 0.1% by weight of an anionic polymer or mixtures thereof.

Tack or Fog Seal Type Surface Coats

A tack coat refers to a coat made of a hydrocarbon binder typically obtained by spraying an emulsion of said hydrocarbon binder onto a pavement coat support. The tack coat is applied to a support in order to consolidate the interface between the support and a layer of bituminous product applied subsequently. The main function of the tack coat is to improve longevity of a pavement, avoiding shearing between coats. The conditions at the interfaces of the layers are very important and the optimum dimensioning of the pavement implies effective and durable bonding of the coats together. The performance of the bonding layer depends especially on the following points:
cohesiveness and setting behavior;
viscosity to allow spraying of the emulsion;
bonding strength between the coats;
the adhesion to the tires which should be limited in order not to generate peeling upon applying the upper coat.

The adhesiveness and cohesiveness of the tack coat depends on the residual binder content applied to the support, the nature of the bituminous coated material, the nature of the support and the cohesion of the bituminous binder employed for the formulation of the tack emulsion. The minimum content of residual binder of a tack coat ranges from 250 to 400 g/m² according to the nature of the coated material as specified in the NF P 98150-1 standard (June 2010). These contents have to be adapted to the condition of the support. The tack coat is spread continuously using a mechanical spreading device; and it can be lightly gritted (for example about 3 L/m² of grit).

Fog seal type surface courses are named from the preparation method of spreading a film of emulsion over a surface. The fog seal method for preparing surface courses advantageously consists in spraying a hydrocarbon binder emulsion after dilution to facilitate application of low contents. The emulsion is usually applied to an existing bituminous surface. The objectives of this method are numerous and consist in particular in improving the aesthetic appearance by providing a homogeneous black color to the roadway, increasing the lifespan of the roadway by protecting the underlying layers from oxidation and water ingress (sealing) and securing the granules on the surface in order to avoid tearing. The residual binder contents of a fog seal coat range between 50 and 230 g/m² depending on the nature and condition of the support. The fog seal coat can be lightly coated with fine sand in order to improve microtexture and adhesion of the wearing course.

A tack coat or fog seal type surface course requires not only an emulsion that is fluid enough to be sprayed, but also an emulsion that has a sufficiently fast break to reopen circulation in a short time.

The breaking rate of an emulsion for an tack coat or fog seal type surface course can be evaluated by a test consisting in measuring the time required for an emulsion to be hardened from its contact with the support. Breakage can be accelerated by simultaneously spreading a bitumen emulsion and a breaking agent (basic sodium carbonate solution, for example) onto the roadway, sprayed into the emulsion jets, allowing the emulsion to break quickly and homogeneously when spread.

The inventors have discovered that useful anionic polymers in the scope of the present invention can make it possible to significantly accelerate breakage of the hydrocarbon binder emulsion, particularly in the absence of a breaking agent.

The cationic hydrocarbon binder emulsion comprising the anionic polymer can be sprayed onto the support and optionally covered by a light content of mineral solid particles.

In the hydrocarbon binder emulsion for making a tack coat, the binder content advantageously ranges from 50 to 75% by weight of the binder, relative to the total weight of the emulsion, more advantageously from 55 to 70% by weight, even more advantageously from 60 to 65% by weight.

In the hydrocarbon binder emulsion for making a fog seal type surface course, the binder content advantageously ranges from 20 to 60% by weight of the binder, relative to the total weight of the emulsion, more advantageously from 25 to 50% by weight, even more advantageously from 30 to 40% by weight. The hydrocarbon binder emulsion is usually with a binder content that ranges from 60 to 65% by weight, and then the hydrocarbon binder emulsion is diluted to reach a binder content as described above.

In the scope of the present invention, the tack coats or surface courses are prepared by means of a hydrocarbon binder cationic emulsion typically comprising, relative to the total weight of the cationic emulsion, from 0,005% to 0.1% by weight of an anionic polymer or mixtures thereof.

Paver Seams

The bitumen emulsion seam paving technique is a very old technique that is particularly well suited to pavements, squares, forecourts, areas with very high traffic, tracks and bus stops, listed or historic sites, town centers and streets, where an original aesthetic covering is required. This technique consists of laying pavers on a laying bed consisting of mineral solid particles, advantageously 0/4 or 0/6 mm sand without fines, while maintaining a spacing of about 1 to 2 cm. The spacings between pavers are then filled with mineral solid particles, usually 2/4 mm particles, and then a hydrocarbon binder emulsion is spread in the spacings between pavers at 10 L/m² to form the flexible seam. Paving is carried out according to standard practice, in accordance with the recommendations of standard NF P 98-335 (May 2007), and those contained in booklet 29 of the CCTG.

The emulsion of hydrocarbon binder used for the paving technique is a fast-breaking cationic emulsion of hydrocarbon binder, in particular of bitumen, having a hydrocarbon binder content of 60 or 65% in order to obtain a fluid emulsion easily penetrating the seams. Once in contact with the mineral solid particles in the spacing between the pavers, the emulsion of hydrocarbon binder should have a rapid and sharp breakage to limit risks of leaching the seam in rainy weather a few hours after preparing the seams. In the scope of the present invention, the cationic emulsion of a hydrocarbon binder comprising an anionic polymer is spread in the spacings between pavers in contact with solid particles (e.g. mineral solid particles).

The inventors have discovered that useful polymers in the present invention can make it possible to greatly accelerate breakage of the hydrocarbon binder emulsion in contact with solid particles in the spacing between pavers.

In the cationic emulsion of hydrocarbon binder, the binder content advantageously ranges from 50 to 75% by weight of the binder, relative to the total weight of the emulsion, more advantageously from 55 to 70% by weight, even more advantageously from 60 to 65% by weight.

In the scope of the present invention, paver seams are prepared by means of a cationic emulsion of a hydrocarbon binder typically comprising, relative to the total weight of the cationic emulsion, from 0.01% to 0.1% by weight of an anionic polymer or mixtures thereof.

### EXAMPLES

### Description of Test Methods

Determination of Adhesiveness of Bitumen Emulsions by Water Immersion Test According to Standard NF EN 13614 (June 2011):

This European standard describes a method for determining adhesion properties of a bitumen emulsion to water-immersed granulates. The bitumen emulsion is thoroughly mixed with selected granulate (washed/dried) under specified conditions (23±5°) C. The mixture is first matured and then immersed in water under specified conditions (60±3°) C. The percentage of binder-covered aggregate surface is visually evaluated under specified conditions.

Determination of Fracture Behavior and Immediate Adhesiveness of Cationic Bitumen Emulsions with 2/4 mm or 4/6.3 mm Granulate (N123-A2f, AFNOR (2019); Modified Procedure of XP CEN/TS 16346 Standard of February 2013):

This method makes it possible to determine the breaking behavior, and qualitatively and quantitatively evaluate immediate adhesiveness of cationic emulsions of hydrocarbon binder in contact with a granulate. This method applies to emulsions used for coating applications.

Specified amounts of emulsion and granulate of 2/4 mm or 4/6.3 mm are mixed under specified conditions. 200 g of granulate are weighed into a capsule and then a conical cavity is drilled into the center of the granulate heap. An amount of emulsion is then poured quickly into the previously formed cavity. The mass is 15.0 g of residual binder when using a 2/4 mm granulate and 12.0 g of residual binder when using a 4/6.3 mm granulate. The time required to agglomerate the granulate into a compact mass is a measure of the breakage time of the emulsion. If complete breakage (agglomeration into a single compact mass) is not obtained within 45 seconds, do not continue mixing and set this out in the test report with “>45”. After 10 minutes ±15 seconds, the final mixture is subjected to a series of water washes (500 ml of clear water at room temperature, 20-25° C.). Once the capsule has been filled with water, wait (5±1) s, then empty the water from the capsule into another beaker through a suitable sieve for retaining the granulate size used. The number of successive washes required to obtain clear water is recorded (No). When successive washes do not result in clear water, the procedure is repeated by spreading the embedded granules and applying the wash procedure after increasing rest times. To obtain clear water, the amount of residual binder fixed by the granules is evaluated by weighing after drying in a ventilated oven at (105±5) ° C. until constant mass is obtained. The percentage by mass of adhering bitumen (qₐ₀) expresses the quantitative adhesiveness.

Determination of Breaking Kinetics and Breaking Homogeneity According to a Specific Non-Standardized Protocol:

An emulsion breaking kinetics evaluation test has been carried out by applying bitumen emulsion with a spatula on a cold mixes (CM) plate at 1.75 kg/m² on an area of 10*10 cm. The emulsion coated area is then gritted with 110 g of 6/10 humid granulates (1% humidity), which corresponds to a content of 11 kg/m², i.e. about 9 L/m². The breakage evaluation is carried out by spraying % of a gritted plate of 10*10 cm at a defined time after gritting while applying a compression-twist movement to its surface, then assessing coloring of the flows reflecting breakage in the mass of the emulsion and its sensitivity to water.

### Example 1: Pure Bitumen Cationic Spreading Emulsions for Surface Dressings

Pure bitumen cationic emulsions have been prepared with the anionic polymers set forth in Table 1.

TABLE 1

| | S1 | S2 | P3 | S4 | P5 |
|---|---|---|---|---|---|
| Reference | FLOSPERSE ® | FLOSPERSE ® | FLOSPERSE ® | FLOSPERSE ® | FLOSPERSE ® |
| | 3030 NCA | CT 39A¹ | 15000 A¹ | 1050A CM¹ | TH 33 M¹ |
| | W30¹ | | | | |
| Form | neutralized | Not neutralized | neutralized | Non-public | Non-public |
| | | | | information | information |
| Total solids | 30% | 40% | 30% | 48% | 36% |
| Anionicity | 70% | 100% | 100% | 100% | 30% |
| Indicative | 4-5 | 4-5 | 4-5 | 1.5-2.5/5.5-6.5 | 4-5 |
| pKa | | | | | |

Description of the anionic polymers tested.
¹marketed by SNF-Floerger

The anionic polymers P1, P2, and P3 correspond to useful anionic polymers in the scope of the present invention. Anionic polymers P4 and P5 are comparative anionic polymers. The anionic polymer P4 comprises ionizable groups having an indicative pKa of 4-5 and ionizable groups having an indicative pKa of 5.5-6.5.

The compositions of the cationic emulsions prepared are set forth in Table 2. In Table 2, the contents set forth are expressed in kilograms per ton of emulsion (kg/t).

TABLE 2

| | R1 | E1 | E2 | E3 | E4 | E5 | EC1 | EC2 |
|---|---|---|---|---|---|---|---|---|
| | Bitumen 70/100 Esso Port Jérôme (content: 690 kg/t) | | | | | | | |
| | Water phase (content: 310 kg/t) | | | | | | | |
| Agent | AT1¹ | AT1¹ | AT1¹ | AT1¹ | AT1¹ | AT2² | AT1¹ | AT1¹ |
| Surfactant | 2.0 | 2.0 | 2.0 | 2.0 | 2.0 | 1.3 | 2.0 | 2.0 |
| (kg/t) | | | | | | | | |
| Acid | HCl | HCl | HCl | HCl | HCl | HCl | HCl | HCl |
| (kt/t) | 1.0 | 1.0 | 1.0 | 1.0 | 1.0 | 1.0 | 1.0 | 1.0 |
| Anionic | / | S1 | S2 | P3 | S2 | S2 | S4 | P5 |
| polymer | 0 | 0.5 | 0.5 | 0.5 | 0.25 | 0.5 | 0.5 | 0.5 |
| (kg/t) | | | | | | | | |
| Water | 307 | 306.5 | 306.5 | 306.5 | 306.75 | 307.2 | 306.5 | 306.5 |
| (kg/t) | | | | | | | | |

Compositions of the cationic emulsions.
¹AT1: Emulsamine ® L60 sold by Arkema.
²AT2: Dinoram ® S marketed by Arkema.

The emulsion R1 is a reference emulsion not comprising an anionic polymer.

Emulsions E1, E2, E3, E4 and ES are emulsions according to the invention.

Emulsions EC1 and EC2 are emulsions comprising an anionic polymer not meeting the criteria defined for useful anionic polymers in the scope of the present invention.

Emulsions R1, E1, E2, E3, E4, E5, EC1 and EC2 have been prepared following the same emulsification protocol, with the same surfactant (HCl/amine).

The properties of the binder emulsions are reported in Table 3.

TABLE 3

| | | | | | | | |
|---|---|---|---|---|---|---|---|
| R1 | E1 | E2 | E3 | E4 | E5 | EC1 | EC2 |

pH: NF EN 12850

| | | | | | | | | |
|---|---|---|---|---|---|---|---|---|
| pH of the | 2.5 | 2.7 | 2.4 | 2.3 | 2.5 | 2.4 | 2.5 | 2.5 |
| aqueous phase | | | | | | | | |
| pH of the | 3.5 | 3.5 | 2.8 | 2.9 | 3.1 | 2.9 | / | 3.3 |
| emulsion | | | | | | | | |

PSEUDO VISCOSITY: NF EN 12846-1

| | | | | | | | | |
|---|---|---|---|---|---|---|---|---|
| STV 4 mm at | 14 | 16 | 69 | 17 | 11 | 15 | / | / |
| 40° C., s | | | | | | | | |
| STV 2 mm at | 161 | 182 | 884 | 187 | 118 | 237 | / | / |
| 40° C., s | | | | | | | | |

HOMOGENEITY by SIEVING: NF EN 1429

| | | | | | | | | |
|---|---|---|---|---|---|---|---|---|
| Rejection at | 0.01 | 0.04 | 0.14 | 0.03 | 0.08 | 0.02 | / | / |
| 0.500 mm (%) | | | | | | | | |
| Rejection at | 0.02 | 0.12 | 0.19 | 0.08 | 0.29 | 0.06 | / | / |
| 0.160 mm (%) | | | | | | | | |

LASER GRANULOMETRY (Malvern): MEI

| | | | | | | | | |
|---|---|---|---|---|---|---|---|---|
| Median Diameter | 8.61 | 10.13 | 8.72 | 7.55 | 10.06 | 9.19 | / | / |
| (μm) | | | | | | | | |
| Standard | 0.34 | 0.37 | 0.29 | 0.33 | 0.37 | 0.33 | / | / |
| Deviation | | | | | | | | |

DYNAMIC VISCOSITY: NF EN 13302

| | | | | | | | | |
|---|---|---|---|---|---|---|---|---|
| Dynamic | 214 | 111 | 398 | 151 | 100 | 130 | / | / |
| viscosity at 40° C. | | | | | | | | |
| (mPa.s) | | | | | | | | |

BREAKING INDEX: NF EN 13075-1

| | | | | | | | | |
|---|---|---|---|---|---|---|---|---|
| Caolin Q92 | 55 | 48 | 72 | 23 | 72 | 56 | / | / |
| Forshammer | 66 | 58 | 86 | 28 | 86 | 67 | / | / |

DECANTATION: NF EN 12847

| | | | | | | | | |
|---|---|---|---|---|---|---|---|---|
| Decantation at 7 | 2.3 | 1.6 | 6.7 | 9.4 | 2.3 | 1.2 | / | / |
| days at 25° C. (%) | | | | | | | | |

Emulsion Properties

The properties of emulsions EC1 and EC2 could not be determined. Emulsion EC1 was found to be unstable from two hours after manufacture, despite the pH of the aqueous phase set to 2.5. Emulsion EC2 in turn was found to be extremely viscous in consistency. Thus, only its pH (3.3) and the binder content (69.1%) could be determined.

The properties of the other emulsions comply with the expected specifications (NF EN 13808). Some variations in properties are observed between the reference emulsion R1 and the emulsions of the invention (E1, E2, E3, E4 and E5). In particular, emulsion E1 has a slightly larger median diameter of bitumen droplets than reference emulsion R1, emulsion E2 has a higher viscosity (STV and dynamic viscosity) than the reference emulsion, and emulsion E3 has a much lower breaking index than measured for emulsion R1. However, the properties measured for all of these emulsions allow use in the surface dressing (SD) technique. This demonstrates that the anionic polymers as defined in the present invention modify only very slightly the properties of bitumen emulsions with respect to a reference emulsion without an anionic polymer. In particular, under conventional manufacturing, storage and transport conditions, bitumen emulsions of the invention are stable.

The passive adhesiveness of the cationic emulsions R1, E1, E2, E3 and E4 has been determined by a water immersion test according to standard NF EN 13614 (June 2011) with 6/10 La Meilleraie granulates (200 g washed and dried). The results are reported in Table 4.

TABLE 4

| | R1 | E1 | E2 | E3 | E4 |
|---|---|---|---|---|---|
| Granulate | 6/10 La Meilleraie - washed/dried | | | | |
| Mineralogical nature | Eruptive material - Diorite rock | | | | |
| Granulate/residual | 200/10 | 200/10 | 200/10 | 200/10 | 200/10 |
| binder mass ratio | | | | | |
| Note | 90 | 90 | 90 | 90 | 90 |
| (% recovery) | | | | | |

Passive adhesiveness of bitumen emulsions by the water immersion test according to standard NF EN 13614 (June 2011)

A satisfactory coating (90% of surface covered after water immersion) has been obtained with 10 g of residual binder for each of the emulsions. These results demonstrate that useful anionic polymers in the invention have no negative impact on the passive adhesiveness between the binder and the granular materials.

The immediate adhesiveness of the cationic emulsions R1, E1, E2, E3, E4 and E5 in contact with granulates 4/6.3 Meilleraie has been evaluated qualitatively and quantitatively according to the modified procedure TS 16346 (September 2019) described in the section “Description of test methods”. This modified procedure is from XP CEN/TS 16346 standard (February 2013). The results are set forth in Table 5.

TABLE 5

| | R1 | E1 | E2 | E3 | E4 | E5 |
|---|---|---|---|---|---|---|
| Granulate 4/6 | compact | compact | compact | compact | compact | Compact |
| La Meilleraie | mass | mass | mass | mass | mass | mass |
| Mixing time (s) | >45 | >45 | >45 | 20 | >45 | >45 |
| Number of | 7 | 1 | 2 | 3 | 2 | 3 |
| washes | | | | | | |
| Immediate | 70 | 100 | 100 | 97 | 100 | 98 |
| quantitative | | | | | | |
| adhesiveness | | | | | | |
| (%) | | | | | | |

Immediate adhesiveness according to modified procedure TS 16346 (September 2019) The results obtained demonstrate that the use of the anionic polymers P1 and P2 does not change the coating behavior: the time required to agglomerate the granules into a compact mass (emulsion breakage time) is not modified by the coagulant polymers apart from the polymer coagulant P3 which reduces this mixing time.

Regarding the number of washes required to obtain a clear water in compact mass, this value is greatly reduced by the addition of the anionic polymers P1, P2 and P3. In particular, the anionic polymer P1 allows clear water to be obtained in a single wash and the immediate quantitative adhesiveness after this wash is 100%. As the rest time before washing the granulates is 10 minutes, the breakage time of the emulsion is therefore evaluated as less than 10 minutes. The anionic polymers as described in the present invention therefore significantly improve breaking kinetics of the emulsion in contact with the granulates and achieve a highly markedly improved immediate quantitative adhesiveness. Emulsion E2 leads to clear water after 2 washes versus 7 washes for the reference emulsion R1 whereas the breaking index of emulsion E2, measured by the test of standard 13075-1, is greater than that measured for the reference emulsion R1. This demonstrates the relevance of the modified procedure of TS 16346 standard (September 2019) for the evaluation of breakage of the emulsion in contact with granulates as well as for the evaluation of the behavior of coagulant polymers in emulsion formulations. Finally, tests carried out with emulsion E5 demonstrate that the polymers of the invention are effective when a different cationic surfactant (Dinroam® S) is used. This shows versatility of the polymers of the invention towards different spreading emulsion formulas.

Breaking kinetics has been evaluated for each emulsion according to the aforementioned protocol. The breakage was assessed at 30 minutes, 1 hour, 2 hours and 3 hours after gritting with materials 6/10 La Meilleraie. The results are shown in Table 6.

TABLE 6

| | R1* | E2 | E4 | E5 |
|---|---|---|---|---|
| t0 + 30 min | Dark brown | Light brown | Light brown | Brown |
| t0 + 1 h | Dark brown | Colorless | Colorless | Brown |
| t0 + 2 h | Dark brown | / | / | Light brown |
| t0 + 3 h | Dark brown | / | / | Colorless |

Breaking Kinetics and homogeneity of the emulsions with materials 6/10 La Meilleraie
*R1 colorless after 24 h

The emulsions according to the invention (E2, E4 and E5) exhibit a homogenous breaking kinetics markedly faster than the reference emulsion (R1).

The effect of anionic polymers has also been demonstrated by performing pH-dependent Zeta potential measurements using a Nanosizer Nano ZS (Malvern Panalyticals). Tests have been carried out by preparing solutions at different pH values in order to observe stability of the bitumen droplets as a function of pH. The results are shown in Table 7.

TABLE 7
Zeta potential (mV)

| pH | R1 | E1 | E2 | E3 | E4 | E5 |
|---|---|---|---|---|---|---|
| 2.0 | 116 | 106 | 108 | 107 | 109 | 99.8 |
| 3.0 | 116 | 112 | 105 | 112 | 110.3 | 95.6 |
| 4.0 | 98 | 87 | 79 | 88 | 88.7 | 71.9 |
| 5.5 | 79 | 67 | 18 | 38 | 25.7 | 22.1 |
| 8.3 | 88 | 31 | −6 | 14 | 30.4 | 10.2 |

pH-dependent Zeta Potential Measurements

The Zeta potential is relatively similar for the different emulsions at a pH below 4. On the other hand, from a pH value of 4, the Zeta potential of the emulsions of the invention (E1, E2 and E3) decreases rapidly unlike the reference emulsion R1 which maintains high Zeta potential values even at high pH.

These results demonstrate the benefit of anionic polymers on the breaking kinetics of emulsions in relation to a rise in pH. Destabilization of emulsions containing the anionic polymers occurs from a pH of 5, a value consistent with the reported value of pKa of the polymers P1, P2 and P3 by the supplier.

### Example 2: Latex Modified Cationic Bitumen Emulsions for Surface Dressings

Latex modified bitumen cationic emulsions have been prepared with the anionic polymer P2 set forth in Table 1.

The compositions of the cationic emulsions prepared are set forth in Table 7. In Table 8, the contents set forth are expressed in kilograms per ton of emulsion (kg/t).

TABLE 8

| | R2 | E6 |
|---|---|---|
| | Bitumen 70/100 Esso Port Jérôme (content: 697 kg/t) | |
| | Water phase (content: 303 kg/t) | |
| Agent | Emulsamine ® L60¹ | Emulsamine ® L60¹ |
| Surfactant | 2.3 | 2.3 |
| (kg/t) | | |
| Acid | HCl | HCl |
| (kt/t) | 1.4 | 1.4 |
| Anionic polymer | / | S2 |
| (kg/t) | 0 | 0.5 |
| Latex | Valoflex ® C1² | Valoflex ® C1² |
| (kg/t) | 15 | 15 |
| Water | 284.3 | 283.8 |
| (kg/t) | | |

Compositions of the cationic emulsions
¹marketed by Arkema
²marketed by Valochem.

Emulsion R2 is a reference emulsion not comprising an anionic polymer.

Emulsion E6 is an emulsion according to the invention. The properties of latex modified bitumen emulsions are reported in Table 9.

TABLE 9

| | |
|---|---|
| R2 | E6 |

pH: NF EN 12850

| | | |
|---|---|---|
| pH of the aqueous phase | 2.1 | 2.1 |
| pH of the emulsion | 2.8 | 2.7 |

PSEUDO VISCOSITY: NF EN 12846-1

| | | |
|---|---|---|
| STV 4 mm at 40° C., s | 9 | 12 |
| STV 2 mm at 40° C., s | 99 | 135 |

HOMOGENEITY by SIEVING: NF EN 1429

| | | |
|---|---|---|
| Rejection at 0.500 mm (%) | 0.01 | 0.01 |
| Rejection at 0.160 mm (%) | 0.06 | 0.08 |

STORAGE STABILITY BY SEEVING: NF EN 1429

| | | |
|---|---|---|
| N (storage days) | 7 | 7 |
| Rejection at 0.500 mm (%) | 0.01 | 0.01 |

LASER GRANULOMETRY (Malvern): MEI

| | | |
|---|---|---|
| Median Diameter (μm) | 7.37 | 7.36 |
| Standard Deviation | 0.39 | 0.4 |

DYNAMIC VISCOSITY: NF EN 13302

| | | |
|---|---|---|
| Dynamic viscosity at 40° C. (mPa · s) | 174 | 571 |

BREAKING INDEX: NF EN 13075-1

| | | |
|---|---|---|
| Caolin Q92 | 94 | 91 |
| Forshammer | 113 | 109 |

Emulsion Properties

The properties of both the reference emulsion R2 and the emulsion of invention E6 comply with the expected specifications (NF EN 13808). Both emulsions have similar properties. This demonstrates that the anionic polymers as defined in the present invention modify only very slightly the properties of bitumen emulsions with respect to a reference emulsion without an anionic polymer. In particular, under conventional manufacturing, storage and transport conditions, bitumen emulsions of the invention are stable.

The immediate adhesiveness of the cationic emulsions R2 and E6 in contact with granulates 4/6.3 La Meilleraie has been evaluated qualitatively and quantitatively according to the modified procedure TS 16346 (September 2019) described in the section “Description of test methods”. This modified procedure is from the XP CEN/TS 16346 standard of February 2013. The results are set forth in Table 10.

TABLE 10

| | R2 | E6 |
|---|---|---|
| Granulate 4/6 La Meilleraie | compact mass | compact mass |
| Mixing time (s) | >45 | >45 |
| Number of washes | 3 | 1 |
| Immediate quantitative adhesiveness | 99 | 99 |
| (%) | | |

Immediate Adhesiveness According to Modified Procedure TS 16346 (September 2019)

The results obtained demonstrate that the use of the anionic polymer P2 does not change the mixing behavior: the time required to agglomerate the granules into a compact mass (emulsion breakage time) is not modified by the coagulant polymer.

Regarding the number of washes required to obtain clear water in compact mass, this value is reduced by the addition of the anionic polymer P2. Only one wash is necessary to obtain clear water and the immediate quantitative adhesiveness after this wash is 99%. The immediate adhesiveness of the cationic emulsions R2 and E6 has also been evaluated in contact with Corneal Vignoc granules 4/6.3 in order to evaluate the efficacy of the present invention with materials having a different petrographic nature. The results are set forth in Table 11.

TABLE 11

| | R2 | E6 |
|---|---|---|
| 4/6 Vignoc Granulate | compact mass | compact mass |
| Mixing time (s) | >45 | >45 |
| Number of washes | >8 | 2 |
| Immediate quantitative adhesiveness | 66 | 96 |
| (%) | | |

The results obtained demonstrate that the use of the anionic polymer P2 significantly reduces the number of washes to obtain clear water and also significantly increases immediate quantitative adhesiveness.

Breaking kinetics has been evaluated for each emulsion according to the aforementioned protocol. The breakage was assessed at 1 h, 2 h, 3 h and 24 h after gritting. The results obtained with the 6/10 La Meilleraie granulates are shown in Table 12.

TABLE 12

| | R2 | E6 |
|---|---|---|
| t0 + 1 h | Dark brown | Light brown |
| t0 + 2 h | Dark brown | colorless |
| t0 + 3 h | Dark brown | colorless |
| t0 + 24 h | colorless | colorless |

Breaking Kinetics and Homogeneity of Emulsions with the Materials 6/10 La Meilleraie

The emulsion according to the invention (E6) exhibits a homogenous breaking kinetics significantly faster than the reference emulsion (R2).

The effect of the anionic polymer P2 has also been demonstrated by performing pH-dependent Zeta potential measurements using a Nanosizer Nano ZS (Malvern Panalyticals) apparatus. Tests have been carried out by preparing solutions at different pH values in order to observe stability of the bitumen droplets as a function of pH. The results are shown in Table 13.

TABLE 13

| | Zeta potential (mV) | |
|---|---|---|
| pH | R2 | E6 |
| 2.0 | 102 | 102.2 |
| 3.0 | 98 | 105.3 |
| 4.0 | 89.3 | 88.3 |
| 5.5 | 70.3 | 51.4 |
| 8.3 | 75.1 | 15.8 |

pH-Dependent Zeta Potential Measurements

The Zeta potential is relatively similar for the different emulsions at a pH below 4. On the other hand, from a pH value of 4, the Zeta potential of the inventive emulsions (E6) decreases rapidly unlike the reference emulsion R2 which maintains high Zeta potential values even at high pH.

These results demonstrate the benefit of polymer P2 on the breaking kinetics of emulsions in connection with a rise in pH. Destabilization of the emulsion containing the anionic polymer P2 occurs from a pH of 5, a value consistent with the value of pKa of the polymer P2 set out by the supplier.

1-13. (canceled)

14. A method for improving immediate adhesiveness of a spreading cationic emulsion of hydrocarbon binder to solid particles, which comprises preparing a cationic emulsion of hydrocarbon binder, wherein
the cationic emulsion comprises an anionic polymer,
the anionic polymer comprises acidic ionizable groups,
all the acidic ionizable groups have a pKa ranging from 4 to 5,
the anionic polymer has an anionicity rate ranging from 50 to 100%,
the anionic polymer has a molecular weight ranging from 500 to 500,000 g/mol, and
wherein the cationic emulsion is spread onto solid particles.

15. The method according to claim 14, wherein the anionic polymer has a molecular weight ranging from 1,000 to 250,000 g/mol.

16. The method according to claim 14, wherein the anionic polymer is derived from the polymerization of acidic ionizable monomers comprising one or more carboxylic or phosphonic groups.

17. The method according to claim 16, wherein the acidic ionizable monomers are chosen from the group comprising acylic acid, methacrylic acid, maleic acid, itaconic acid, fumaric acid, and mixtures thereof.

18. The method according to claim 14, wherein the anionic polymer is chosen from the group comprising acrylic acid homopolymers, acrylic acid/acrylamide copolymers, maleic acid/acrylic acid copolymers, methacrylic acid homopolymers, acrylic acid/methacrylic acid copolymers, acrylic acid/acrylate copolymers, and acrylic acid terpolymers.

19. The method according to claim 14, wherein preparing the cationic emulsion comprises the following steps of:
(a) incorporating the anionic polymer into an aqueous phase comprising at least one cationic surfactant, the pH of the aqueous phase being between 1.5 and 2.5; and then
(b) emulsifying the aqueous phase from step a) by adding a hydrocarbon binder.

20. The method according to claim 14, wherein the cationic emulsion comprises from 0,005 to 0.5% by mass of the anionic polymer relative to the total mass of the emulsion.

21. The method according to claim 14, wherein the immediate quantitative adhesiveness of the spreading cationic emulsion on solid particles is greater than 90% after less than eight water washes, as measured according to the modified test (AFNOR N123-A2f, 2019) of TS 16346(2013) standard.

22. A method for preparing a bituminous product comprising
providing a support,
applying by spreading a cationic emulsion of hydrocarbon binder on the surface of the support, and then
applying a layer of solid particles over the spread cationic emulsion of hydrocarbon binder,
wherein the cationic emulsion comprises an anionic polymer,
the anionic polymer comprises acidic ionizable groups,
all the acidic ionizable groups have a pKa ranging from 4 to 5,
the anionic polymer has an anionicity rate ranging from 50 to 100%,
the anionic polymer has a molecular weight ranging from 500 to 500,000 g/mol.

23. The method according to claim 22, wherein the bituminous product is surface dressings.

24. The method according to claim 23, wherein the cationic emulsion is prepared by:
(a) incorporating the anionic polymer into an aqueous phase comprising at least one cationic surfactant, the pH of the aqueous phase being between 1.5 and 2.5; and then
(b) emulsifying the aqueous phase from step a) by adding a hydrocarbon binder.

25. The method of claim 23, wherein the cationic emulsion comprises from 0.01% to 0.1% by weight of the anionic polymer, relative to the total weight of the cationic emulsion.

26. A method for preparing a bituminous product comprising the steps of:
providing a layer comprising solid particles; and
applying by spreading a cationic emulsion of hydrocarbon binder on the surface of the layer of solid particles,
wherein the cationic emulsion comprises an anionic polymer,
the anionic polymer comprises acidic ionizable groups,
all the acidic ionizable groups have a pKa ranging from 4 to 5,
the anionic polymer has an anionicity rate ranging from 50 to 100%,
the anionic polymer has a molecular weight ranging from 500 to 500,000 g/mol.

27. The method according to claim 26, wherein the bituminous product is chosen from tack coats and fog seal-type surface courses.

28. The method according to claim 27, wherein the cationic emulsion comprises from 0.005% to 0.1% by weight of the anionic polymer, relative to the total weight of the cationic emulsion.

29. The method according to claim 27, wherein the bituminous product is a tack coat and the method further comprises adding another layer comprising solid particles over the spread cationic emulsion of hydrocarbon binder.

30. The method according to claim 26, wherein the bituminous product is paver seam.

31. The method according to claim 30, wherein the layer comprising solid particles consists in a layer of pavers having spacings between each paver, the spacings being filled with solid particles.

32. The method according to claim 31, wherein the cationic emulsion is spread on the surface of the spacings filled with the solid particles.

33. The method according to claim 30, wherein the cationic emulsion comprises from 0.01% to 0.1% by weight of the anionic polymer, relative to the total weight of the cationic emulsion.
